(19) United States
(12) Patent Application Publication
(10) Pub. No.: US 2026/0312923 A1
(43) Pub. Date: Oct. 8, 2026

(54) GRAPH-BASED CONVERSATION STATE TRACKING IN VIRTUAL ASSISTANT COMMUNICATION SESSIONS

(71) Applicant: FMR LLC, Boston, MA (US)

(72) Inventors: Thilak Thirumurthy-Siva, Sharon, MA (US); Tieyi Guo, Frisco, TX (US); Byung Chun, Kingston, MA (US); Amanda Bedard, Mainville, OH (US); Christopher A. Bright, Lehi, UT (US); Colby Hill, Draper, UT (US); Navleen Singh, Covington, KY (US)

(21) Appl. No.: 19/098,010

(22) Filed: Apr. 2, 2025

(51) Int. Cl. H04L 51/02; G06F 16/3329; G06F 16/335; G06F 16/901; G06F 40/35

(52) U.S. Cl. CPC H04L 51/02; G06F 16/33295; G06F 16/335; G06F 16/9024; G06F 40/35

(57) ABSTRACT

Methods and apparatuses for graph-based conversation state tracking in virtual assistant communication sessions. A server generates a conversation graph associated with a chat-based communication session between a virtual assistant application and a client device. The server captures utterances generated by a user of the client device during the chat session. For each of the utterances, the server generates an utterance node in the graph based upon the utterance; identifies a topic associated with the utterance and connects the utterance node to a topic node in the graph; determines a responsive action based upon the utterance and connects the utterance node to an action node in the graph; executes the responsive action to generate an answer to the utterance and connects the action node to an answer node in the graph; and transmits a message to the client device with the generated answer for display to the user.

### TECHNICAL FIELD

This application relates generally to methods and apparatuses, including computer program products, for graph-based conversation state tracking in virtual assistant communication sessions.

### BACKGROUND

As computing technology has become commonplace, many users have abandoned the use of live telephone conversations with service agents and representatives to answer questions and resolve issues, in favor of electronic communications such as text-based online chat sessions over the Internet involving the use of computing devices and related chat-based software. To efficiently manage this form of communication, many organizations are turning to automated conversation service software applications (such as virtual assistants (VAs) and chatbots) to interact with end users intelligently using advanced language processing and data interpretation technology. Typically, such automated systems follow a linear, task-oriented script that analyzes individual messages coming from an end user in order to determine the user's intent and maps the intent to pre-defined outcomes or actions so that the VA software can respond in a way that meets the end user's needs or goals.

In order to provide a human-like interaction to the end user, conversation service software must be able to perform context retention and state tracking. Generally, context retention refers to the ability of a VA system to remember and utilize the information from previous interactions within a conversation. Context retention helps the VA system to maintain a natural conversation flow by referring to previous inputs or data provided by the end user. Generally, state tracking (also known as dialogue state tracking (DST)) is about keeping track of the current state/context of a conversation. State tracking involves the VA application being able to understand where in the conversation the user currently is, what actions have been performed, and what the next steps might be. State tracking is more about managing and guiding the conversation flow in real-time based on the current interaction. Thus, a difference between the two concepts is that context retention is about remembering past interactions, while state tracking is about understanding the present status of the conversation.

However, intent-based, scripted VA software usually lacks complex decision-making capability and adaptability in appropriately generating responses to user messages during a chat session. In addition, such VA software may be difficult to change or scale as user needs evolve, due to the inflexibility of the scripted intent structure. This results in a chatbot with reduced accuracy and effectiveness which limits the overall user experience.

### SUMMARY

Therefore, what is needed are methods and systems that provide for advanced, dynamic context retention and state tracking in virtual assistant (VA) application software.

Context retention and state tracking are important in supporting multi-turn interactions. Example use cases for the methods and systems described herein include, but are not limited to:
1. Non-linear Conversations—an end user may talk about Topics A, B, and C during a conversation, and then later refer back to an item that was mentioned in Topic A. The methods and systems advantageously handle nonlinearity (without asking the end user to repeat themselves) by maintaining the entities, topics and objectives that the end user referenced during the conversation for that topic.
2. Intelligent Multi-Intent Conversation—multi-intent utterances can be expressed in many ways. A multi-intent utterance may need to be broken up into several sub-utterances and they need to be chained together in different arrangements to provide a response depending on the incoming utterance.
3. Chained Utterances—end users can send multiple utterances which keep expanding the context of the user's objective with every incoming utterance. The method and systems can handle such scenarios. An example series of utterances might be: “Does my IRA (Individual Retirement Accounts) accounts allow me to buy stocks,” “particularly international,” “and penny stocks” as three consecutive chained utterances. As can be appreciated, each utterance adds further context to the user's real objective.
4. Context Management—end users can refer to entities that they (and/or the VA software) mentioned in the earlier parts of a nonlinear conversation. The methods and systems described herein enable retention and use of the context. As an example, the end user can submit the following utterance: “What are short-term investment options?” and the VA software responds with “Money markets, CD's, treasury bills.” Then, the end user switches to a different topic and the conversation continues. Later, the end user again asks: “Among the short-term investment options you provided which has the highest yield?” The systems and methods beneficially retain the context and the entities both referenced by the end user and the VA software and utilize the context/entities during the conversation.
5. Deviations—end users might leave a conversational thread in an incomplete state and navigate to a new topic of conversation. During a particular action, they might decide to ask for more information before completing the action. As an example, an end user can ask: “I want to find an earnings call date,” to which the VA software responds, “Which company's earnings call date are you looking for?” At this point, the end user may respond with a company name or decide to ask a clarifying question, e.g., “What companies have earnings calls?” The methods and systems described herein advantageously remembers the chain of interaction if the end user provides a company name at a later time in the conversation. As another example, the user might decide to ask for an account balance during a money transfer operation.

As noted in the above examples, a multi-turn interaction can have the following aspects:
1. A conversation can span across multiple topics.
2. A single utterance might cover multiple topics and multiple objectives.
3. A conversation can transition from one utterance to another, either continuing to add more context to the current topic or transitioning to a different topic.
4. During a conversation, there may be several entities referenced. The scope of these entities referenced need to be mapped to either to the current utterance, current topic, or the entire conversation.
5. To fulfil a conversation, VA software can request certain information/entities/affirmations from the end user to provide better assistance and handle ambiguities or clarifications.
6. An utterance from the user can chain together multiple sub-questions that need to be chained in different methods to provide an eventual answer to the end user.
7. Depending on the state of a conversation, proactive messages or contextual recommendations can be sent to the end user via VA software.
8. A requirement to handle, track, and respond to non-relevant parts of a conversation.
9. A requirement to track the sentiment and the emotional quotients of a conversation.
10. A requirement to track the states of the conversational threads to capture the fulfilled, deviated, or queued parts of the conversation.

The invention, in one aspect, features a computer system for graph-based conversation state tracking in virtual assistant communication sessions. The system includes a server computing device having a memory that stores computer-executable instructions and a processor that executes the computer-executable instructions. The server computing device generates a conversation graph associated with a chat-based communication session between a virtual assistant application of the server computing device and a client computing device. The server computing device captures a plurality of utterances generated by a user of the client computing device during the chat-based communication session. For each of the plurality of utterances, the server computing device generates an utterance node in the conversation graph based upon the utterance; identifies a topic associated with the utterance and connects the utterance node to a topic node for the topic in the conversation graph; determines a responsive action based upon the utterance and connects the utterance node to an action node for the responsive action in the conversation graph; executes the responsive action to generate an answer to the utterance and connects the action node to an answer node for the answer in the conversation graph; and transmits a message to the client computing device comprising the generated answer for display to the user during the chat-based communication session.

The invention, in another aspect, features a computerized method of graph-based conversation state tracking in virtual assistant communication sessions. A server computing device generates a conversation graph associated with a chat-based communication session between a virtual assistant application of the server computing device and a client computing device. The server computing device captures a plurality of utterances generated by a user of the client computing device during the chat-based communication session. For each of the plurality of utterances, the server computing device generates an utterance node in the conversation graph based upon the utterance; identifies a topic associated with the utterance and connects the utterance node to a topic node for the topic in the conversation graph; determines a responsive action based upon the utterance and connects the utterance node to an action node for the responsive action in the conversation graph; executes the responsive action to generate an answer to the utterance and connects the action node to an answer node for the answer in the conversation graph; and transmits a message to the client computing device comprising the generated answer for display to the user during the chat-based communication session.

Any of the above aspects can include one or more of the following features. In some embodiments, generating a conversation graph comprises creating a root node in the conversation graph upon establishing the chat-based communication session between the virtual assistant application of the server computing device and the client computing device, the root node including a conversation identifier attribute. In some embodiments, generating an utterance node in the conversation graph comprises connecting the utterance node to the root node. In some embodiments, establishing the chat-based communication session between the virtual assistant application of the server computing device and the client computing device comprises: determining an identity of the user based upon indicia received from the client computing device; retrieving one or more user profile attributes based upon the identity of the user; generating one or more identity nodes in the conversation graph based upon the user profile attributes; and connecting the one or more identity nodes to the root node.

In some embodiments, connecting the utterance node to a topic node for the topic in the conversation graph comprises: determining whether a topic node for the topic exists in the conversation graph; when the topic node for the topic exists in the conversation graph, connecting the utterance node to the existing topic node; and when the topic node for the topic does not exist in the conversation graph, generating a new topic node for the topic and connecting the utterance node to the new topic node. In some embodiments, the action node for the responsive action in the conversation graph comprises a function call that, when executed, connects the server computing device to a data source for retrieval of data used to generate the answer to the utterance. In some embodiments, the action node for the responsive action in the conversation graph comprises a function call that, when executed, retrieves data used to generate the answer to the utterance from another node in the conversation graph.

In some embodiments, for each of the plurality of utterances, the server computing device determines whether the utterance comprises a plurality of sub-utterances. In some embodiments, for each utterance that comprises a plurality of sub-utterances, the server computing device generates an utterance node in the conversation graph based upon the sub-utterance; identifies a topic associated with the sub-utterance and connects the utterance node to a topic node for the topic in the conversation graph; determines a responsive action based upon the sub-utterance and connects the utterance node to an action node for the responsive action in the conversation graph; executes the responsive action to generate an answer to the sub-utterance and connects the action node to an answer node for the answer in the conversation graph; and transmits a message to the client computing device comprising the generated answer for display to the user during the chat-based communication session. In some embodiments, for the plurality of sub-utterances, the server computing device: generates a first utterance node in the conversation graph based upon a first sub-utterance of the plurality of sub-utterances; identifies a topic associated with the first sub-utterance and connects the first utterance node to a topic node for the topic in the conversation graph; determines a need for further sub-utterance processing based upon the first sub-utterance; generates a second utterance node in the conversation graph based upon a second sub-utterance of the plurality of sub-utterances and connects the second utterance node to the first utterance node; determines a responsive action based upon the second sub-utterance and connects the second utterance node to an action node for the responsive action in the conversation graph; executes the responsive action to generate an answer to the second sub-utterance and connects the action node to an answer node for the answer in the conversation graph; and transmits a message to the client computing device comprising the generated answer for display to the user during the chat-based communication session.

In some embodiments, when the chat-based communication session has ended, the server computing device analyzes the conversation graph to: identify conversation anomalies; determine common topics between the conversation graph and conversation graphs for other users; extract key nodes from the conversation graph; predict relationships between nodes for subsequent communication sessions; and determine conversation dependencies. In some embodiments, the conversation graph comprises a short-term memory graph data structure.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for graph-based conversation state tracking in virtual assistant communication sessions.

FIG. 2 is a flow diagram of a computerized method of graph-based conversation state tracking in virtual assistant communication sessions.

FIG. 3 is a diagram of a first exemplary portion of a conversation session workflow and a corresponding portion of a conversation graph relating to receipt and processing of an initial user utterance.

FIG. 4 is a diagram of a second exemplary portion of a conversation session workflow and a corresponding portion of a conversation graph relating to determining a responsive action to an utterance.

FIG. 5 is a diagram of a third exemplary portion of a conversation session workflow and a corresponding portion of a conversation graph relating to executing a responsive action and generating a response.

FIG. 6 is a diagram of an exemplary conversation graph generated from a complete conversation session.

### DETAILED DESCRIPTION

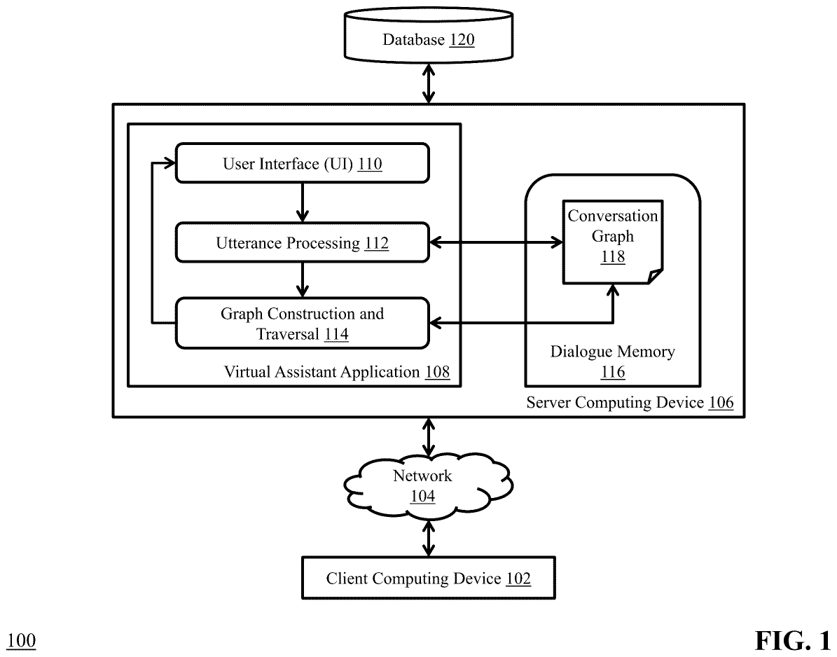

FIG. 1 is a block diagram of a system 100 for graph-based conversation state tracking in virtual assistant communication sessions. System 100 includes client computing device 102, communications network 104, and server computing device 106 that includes virtual assistant (VA) application 108 with user interface (UI) module 110, utterance processing module 112, and graph construction and traversal module 114, and dialogue memory 116 which includes conversation graph data structure 118. System 100 also includes database (DB) 120 coupled to server computing device 106.

Client computing device 102 connects to one or more communications networks (e.g., network 104) in order to communicate with computing device 106 to provide input and receive output relating to one or more chat-based communication sessions as described herein. Exemplary client computing devices 102 include but are not limited to server computing devices, desktop computers, laptop computers, tablets, mobile devices, smartphones, and the like. It should be appreciated that other types of client computing devices that are capable of connecting to the components of the system 100 can be used without departing from the scope of invention. Although FIG. 1 depicts one client computing device 102, it should be appreciated that system 100 can include any number of client computing devices. In some embodiments, client computing device 102 is configured with chat application software, which enables client computing device 102 to establish a chat-based communication session with server computing device 106 via virtual assistant application 108 of server computing device 106.

Communications network 104 enables client computing device 102 to communicate with server computing device 106. Network 104 is typically comprised of one or more wide area networks, such as the Internet and/or a cellular network, and/or local area networks. In some embodiments, network 104 is comprised of several discrete networks and/or sub-networks (e.g., cellular to Internet).

Server computing device 106 is a device including specialized hardware and/or software modules that execute on one or more processors and interact with memory modules (including but not limited to dialogue memory 116) of server computing device 106, to receive data from other components of system 100, transmit data to other components of system 100, and perform functions for graph-based conversation state tracking in virtual assistant communication sessions as described herein. Server computing device 106 includes virtual assistant (VA) application 108 that executes on one or more processors of server computing device 106 and includes UI module 110, utterance processing module 112, and graph construction and traversal module 114. In some embodiments, modules 110, 112, 114 of VA application 108 are specialized sets of computer software instructions programmed onto one or more dedicated processors in server computing device 106.

As can be appreciated, in some embodiments virtual assistant application 108 comprises a conversation service software application (i.e. chatbot) configured to automatically interact with a user at client computing device 102 in order to gather information and/or respond to inquiries. An exemplary conversation service software application can be based upon a natural language processing (NLP) and/or natural language understanding (NLU) architecture which intelligently parses text messages received from client computing device 102 to understand the context of the message(s) (e.g., by identifying topics/subtopics in the message) and how to generate an appropriate response to the message(s). In some embodiments, VA application 108 can establish a chat-based communication session with client computing device 102 to enable the user at client computing device 102 to participate in an automated chat session with VA application 108. In these embodiments, UI module 110 of VA application 108 provides a chat interface for the exchange of messages with client computing device 102. It should be appreciated that the user can interact with VA application 108 using a text-based interface, a voice-based interface, or both. For example, the voice-based interface can leverage Text to Voice (TTV) and Voice to Text (VTT) technologies, enabling users to interact with VA application 108 through spoken commands and receive audible responses. System 100 dynamically adapts between text and voice modes based on user preference, device capability, and context of use, providing a flexible and user-friendly interaction method.

In some embodiments, client computing device 102 includes an application that executes on client computing device 102 to provide certain functionality to an end user. In some embodiments, client computing device 102 can include a native application installed locally on client computing device 102. For example, a native application is a software application (also called an ‘app’) that written with programmatic code designed to interact with an operating system that is native to client computing device 102 and provide information and application functionality (such as a chatbot interface) to a user of client computing device 102. In the example where client computing device 102 is a mobile device such as a smartphone, the native application software is available for download from an online repository such as, e.g., the Apple® App Store or the Google® Play Store. In some embodiments, the native application includes a software development kit (SDK) module that is executed by one or more processors of client computing device 102. In other embodiments, client computing device 102 can include a browser application that runs on client computing device 102 and connects to one or more other computing devices (e.g., server computing device 106) for retrieval and display of information and application functionality (such as conducting a chat-based communication session with VA application 108). In one example, the browser application enables client computing device 102 to communicate via HTTP or HTTPS with server computing device 106 (e.g., via a URL) to receive website-related content, including one or more webpages, for rendering in the browser application and presentation on a display device coupled to client computing device 102. Exemplary browser application software includes, but is not limited to, Firefox™, Chrome™, Safari™, and other similar software. The one or more webpages can comprise visual and audio content for display to and interaction with a user.

VA application 108 includes a plurality of computing modules—UI module 110, utterance processing module 112, and graph construction and traversal module 114—that execute on one or more processors of server computing device 106. In some embodiments, modules 110, 112, 114 are specialized sets of computer software instructions programmed onto one or more dedicated processors in server computing device 106 and can include specifically designated memory locations and/or registers for executing the specialized computer software instructions.

Although modules 110, 112, 114 are shown in FIG. 1 as executing within VA application 108 on server computing device 106, in some embodiments the functionality of modules 110, 112, 114 can be distributed among a plurality of server computing devices. As shown in FIG. 1, server computing device 106 enables modules 110, 112, 114 to communicate with each other in order to exchange data for the purpose of performing the described functions. It should be appreciated that any number of computing devices, arranged in a variety of architectures, resources, and configurations (e.g., cluster computing, virtual computing, cloud computing) can be used without departing from the scope of the invention. The exemplary functionality of modules 110, 112, 114 is described in detail throughout the specification.

Dialogue memory 116 is an in-memory data store located on server computing device 106 and coupled to VA application 108. Dialogue memory 116 is configured to provide low latency access to, and high availability of, data stored therein. Conversation graph 118 is a modular data structure configured to dynamically handle conversation state information and retain conversation context in real time during a virtual assistant communication session. As can be appreciated, the graph structure of conversation graph 118 is better suited for tracking the state of a non-linear virtual assistant conversation, because a graph structure inherently provides several key technical benefits over traditional linear structures:
A graph structure inherently provides entities (nodes) and relationships (edges), where the properties of nodes provide attributes associated with a node and the interconnection between nodes can be qualified with properties on relationships.
Multiple relationships can be established between nodes, and the same parameter(s)/entit(ies) can be used across different topics of conversations. As an example, the conversation graph can be configured to have a single ‘age’ node that represents an age of the customer/end user participating in the conversation.
Graphs are dynamic in nature; new nodes and descriptive relationships can be added as needed.
Concepts of inheritance are naturally built into conversation graphs, e.g., nodes can be structured to have a parent-child relationship.
Graph data structures are easy to represent in a visual/graphical manner, e.g., for a product/business owner to review.
Graph traversal makes handling complex relationships straightforward.
Conversation state attributes can be retrieved from a graph on an as-needed basis, thereby enabling efficient use of memory and processing resources.

Generally, a conversation node (root note) forms the parent for any new conversation and the utterances, sub questions and the details around the conversation are tracked per topic. In some embodiments, conversation graph 118 is stored in short term memory (e.g., dialogue memory 116

Each node in the conversation graph 118 can comprise a plurality of data elements that contain information such as attributes of the corresponding node. In some embodiments, the attributes of each node are stored as key-value pairs in the graph 118. Each node can be assigned a unique identifier that enables VA application 108 to locate the node quickly during traversal of the conversation graph 118. In some embodiments, nodes in the conversation graph 118 can be assigned a specific node type—for example, a node can be designated as an utterance node, a topic node, an action node, an answer node, or another type of node. An utterance node can include information corresponding to an utterance received by VA application 108 from, e.g., an end user at client computing device 102 who is participating in a conversation session. For example, an utterance node can include a text string of the user's utterance or one or more keywords from the user's utterance, as captured by VA application 108 during the conversation session.

A topic node can include a text string or an identifier that denotes a specific topic represented in the utterance(s) submitted by the end user during the conversation session. Generally, topics can be associated with subject matter, intent and/or conversation context of the user utterances. In one example, if a user submits an utterance comprising the question: “When is the Q4 earnings call for XYZ Corp.?,” the topic for this utterance can be “Investment Advice.” In some embodiments, VA application 108 uses an NLP and/or NLU module to interpret the incoming utterance and, e.g., determine a topic of the utterance. Based upon the determined intent, VA application 108 can (i) identify an existing node structure in dialogue memory 116 that corresponds to the determined topic (e.g., an “Investment Advice” topic node) and insert an instance of the existing node structure in the graph 118 and/or (ii) generate a new topic node for the determined topic and insert an instance of the new topic node in the graph 118.

An action node can include information referencing one or more application workflow agents that are associated with executable code (e.g., a function call, a programmatic script, a web artifact, a code module, an API call) that performs an action related to and/or responsive to one or more of the user utterances. In some embodiments, action nodes can store one or more data elements from other nodes of the conversation graph 118 that is used as input to the workflow agents for processing. As an example, an action node can be configured to represent the execution of a function call to a data source for retrieval of information responsive to a user utterance—if a user asks “What is the current share price of Acme, Inc.?,” an action node can store the string “Acme” and/or a corresponding ticker symbol from an utterance node for the utterance as an input attribute, capture and store indicia associated with an function call executed by VA application 108 to search a database or other data source for the information, and store output from the database search in an output attribute.

An answer node can include information associated with the generation of a response to a user utterance by VA application 108, e.g., based upon output stored in an action node. For example, VA application 108 can use the output from an action node to generate a customized response to a user utterance through the use of a template—a template string to the above utterance can be “The share price of <ticker> is <price>,” where <ticker> is the value of the ticker symbol attribute from the action node input and <price> is the value of the price attribute from the action node output. VA application 108 can generate a response using the template and then create an answer node that stores the response and any related attributes. In some embodiments, an answer node can refer to programmatic instructions (e.g., a workflow agent) that is executed by VA application 108 to create the response as above and insert the response as a message during the conversation session with client computing device 102.

In some embodiments, nodes in the conversation graph 118 can be conditional—in that the nodes include a condition statement and/or attributes evaluated by VA application 108 when determining, e.g., whether to execute an action, generate an answer, request additional information, or perform another function based upon the current state of the conversation session.

As can be appreciated, there may be other types of nodes that can be used in the conversation graph 118 data structure described herein. For example, the graph may include a conversation context node that contains information associated with the context of the conversation session—such as user attributes (e.g., name, age, customer ID). VA application 108 can be configured to utilize the context node(s) during a conversation session to request information from the end user, prepare responses, and perform actions, and otherwise provide for a customized interaction with the end user. In some embodiments, VA application 108 can generate and store context nodes, e.g., when the conversation session is instantiated between the client computing device 102 and the VA application 108. For example, the VA application 108 can request user-identifying information and/or authentication information from client computing device 102 at the beginning of a conversation session. VA application 108 can retrieve a profile of the end user at client computing device 102 based upon the user-identifying information and/or authentication information and use the profile to populate the context nodes.

Database 120 is a computing device (or set of computing devices) coupled to server computing device 106 and configured to receive, generate, and store specific segments of data relating to the process of graph-based conversation state tracking in virtual assistant communication sessions as described herein. In some embodiments, system 100 can include a plurality of databases. In some embodiments, the entire database 120 or a portion of database 120 can be integrated with server computing device 106 or be located on a separate computing device or devices. Database 120 can comprise one or more databases configured to store portions of data used by the other components of system 100, as described throughout the specification.

In some embodiments, system 100 can further include one or more NLP/NLU services (not shown) coupled to server computing device 106. Each NLP/NLU service can comprise a computing resource that is configured to analyze incoming user messages (e.g., utterances received from client computing device 102 as part of a virtual assistant communication session with VA application 108) and provide a determined intent associated with the user utterance(s). As can be appreciated, a main goal of many virtual assistant applications 108 is to parse incoming user utterances, process the messages using an NLP/NLU module to understand the user's input and to determine a user intent for the utterances. Then, based upon the determined user intent, the virtual assistant application 108 can identify a behavior tree or trees to traverse in order to formulate a response to the user utterances (e.g., provides information, answers a question, initiates a transaction, etc.) that satisfies the user intent and continues the conversation flow. In some embodiments, NLP/NLU services can be application programming interfaces (APIs) that are called by VA application 108 using one or more function calls including parameters such as the user utterances. It should be appreciated that NLP/NLU services can be located on server computing device 106 and/or one or more computing devices that are separate from server computing device 106 (e.g., service endpoints, remote servers and the like). Exemplary NLP/NLU services include but are not limited to Google® Dialogflow™, Amazon® Lex™, Microsoft® Azure Bot™, OpenAI™ ChatGPT™, and others. For example, the NLP/NLU services can be proprietary in-house models (e.g., based on one or more open source LLMs trained using organization-specific and/or domain-specific data)—which may promote better security and customization options, while also improving response time. In some embodiments, the NLP/NLU services can utilize advanced machine learning algorithms, such as generative pre-trained transformer models or large language models (LLMs), to evaluate input and generate output.

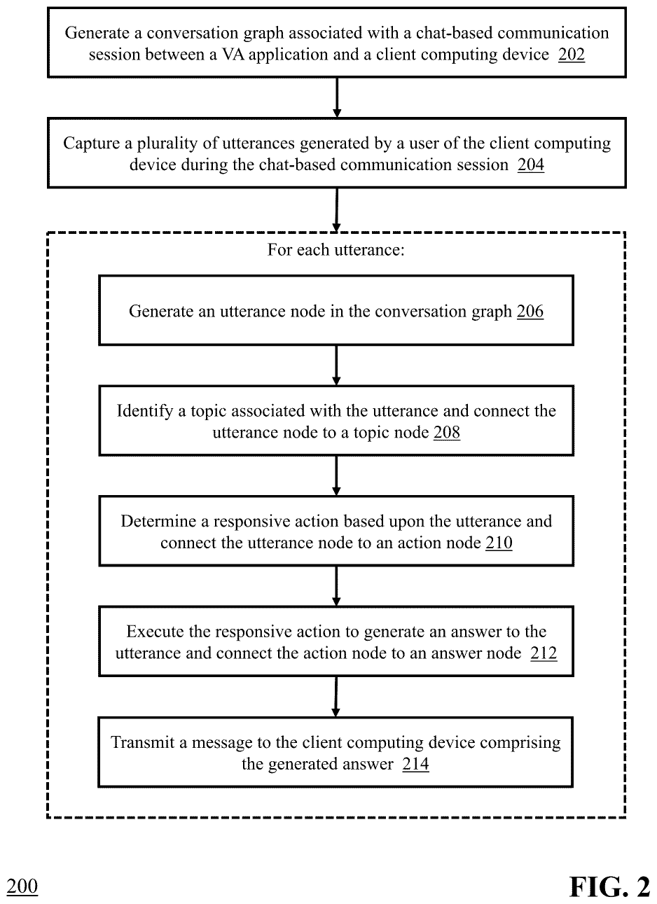

FIG. 2 is a flow diagram of a computerized method 200 of graph-based conversation state tracking in virtual assistant communication sessions, using system 100 of FIG. 1. A user at client computing device 102 can launch an application (e.g., app, browser) to perform a variety of tasks, including but not limited to information retrieval from local and/or remote data sources. For example, when the application is a browser application, the user can interact with the application to access one or more websites and/or webpages (either internally or externally hosted) in order to view information and submit queries for retrieval of additional information. In one embodiment, the user of client computing device 102 is a customer accessing a company website to retrieve information (e.g., product information, account information, customer service information, and the like).

As can be appreciated, in some instances the information that the customer is seeking may not be readily available or the customer may have additional questions that he or she cannot resolve using only the information provided by the application. In these instances, the customer may want to conduct a chat-based communication session with server computing device 106 via virtual assistant application 108. For example, a customer at client computing device 102 may want to connect to VA application 108 for real-time, automated assistance in resolving a problem, performing a transaction, or answering a question. The customer at device 102 can launch a function in the app and/or activate a link in a webpage displayed in the browser to initiate a network connection (e.g., HTTP) to VA application 108 on server computing device 106.

In some embodiments, at the point when the connection is established between client computing device 102 and VA application 108, a new chat session is created and lasts for a defined period of time (e.g., thirty minutes). During this timeframe, all chat session history is used to resolve the conversation context. The session is per customer per timeframe—similar to a conversation with a person, which could last for thirty minutes or could end earlier. In this context, whichever time period is shorter defines the chat session.

Server computing device 106 establishes a chat-based communication session with client computing device 102 via virtual assistant application 108. In some embodiments, at the time the session is established, graph construction and traversal module 114 generates (step 202) a conversation graph 118 associated with the communication session. For example, utterance module 112 can assign a unique identifier to the communication session, then module 114 can instantiate a new conversation graph 118 data structure in dialogue memory 116 and create a root node in the graph 118 that contains the unique identifier for the session. As explained herein, the root node represents a starting point for the conversation flow and, in some instances, the root node can indicate to VA application 108 where traversal of the conversation graph 118 should begin. Typically, at the outset of a conversation session, the first (and only) node in the conversation graph 118 is the root node. As will be explained below, as events occur in the conversation, additional nodes are inserted into the graph 118 and connected to the root node and/or other nodes to create the structure of the conversation. In some embodiments, the conversation graph 118 is stored in dialogue memory 116 that is based upon the Neo4j™ database (neo4j.com).

When the conversation session is established, UI module 110 of VA application 108 can transmit one or more messages to client computing device 102 that greet the user and ask the user how VA application 108 can help. The user at client computing device 102 can submit one or more user messages (also called utterances) that relate to the user's reason or purpose for initiating the chat-based communication session (e.g., a statement, a request for information, a question). Utterance processing module 112 of VA application 108 captures (step 204) utterances generated by the user of client computing device 102 during the chat-based communication session. In some embodiments, VA application 108 receives one or more data packets from client computing device 102 during the chat session that contain user utterances in packet payload and/or metadata. VA application 108 can extract the user utterances from the data packets as they arrive from client computing device 102 and store the utterances in dialogue memory 116 allocated to the chat session).

As can be appreciated, a chat session (or conversation session) represents a state-based conversation flow between client computing device 102 and VA application 108, where VA application 108 parses user utterances, carries out one or more workflow actions relevant to the user utterances, and generates appropriate responses. In some embodiments, VA application 108 performs specific workflow actions (e.g., information retrieval, transaction processing) as necessary to generate the responses. Beneficially, system 100 is configured to capture each utterance, topic, action, answer, and context information associated with the conversation session into a graph structure that can be constructed and traversed by VA application 108 during the session to provide a dynamic mechanism for conversation state tracking and user utterance fulfilment that improves existing chatbots and VA systems. In addition, graph structures generated by system 100 can be stored and retrieved for subsequent analysis, including determining conversation trends and patterns across multiple end users.

For each utterance that is received from client computing device 102, utterance processing module 112 and graph construction and traversal module 114 of VA application 108 process the utterance to create and update nodes in the conversation graph 118. In some embodiments, VA application 108 generates (step 206) an utterance node in the conversation graph 118 based upon the utterance, identifies (step 208) a topic associated with the utterance and connects the utterance node to a topic node for the topic in the conversation graph 118, determines (step 210) a responsive action based upon the utterance and connects the utterance node to an action node for the responsive action in the conversation graph 118, and executes (step 212) the responsive action to generate an answer to the utterance and connects the action node to an answer node for the answer in the conversation graph. VA application 108 then transmits (step 214) a message to client computing device 102 comprising the generated answer for display to the user during the chat-based communication session. Further detail regarding each of these steps is provided below.

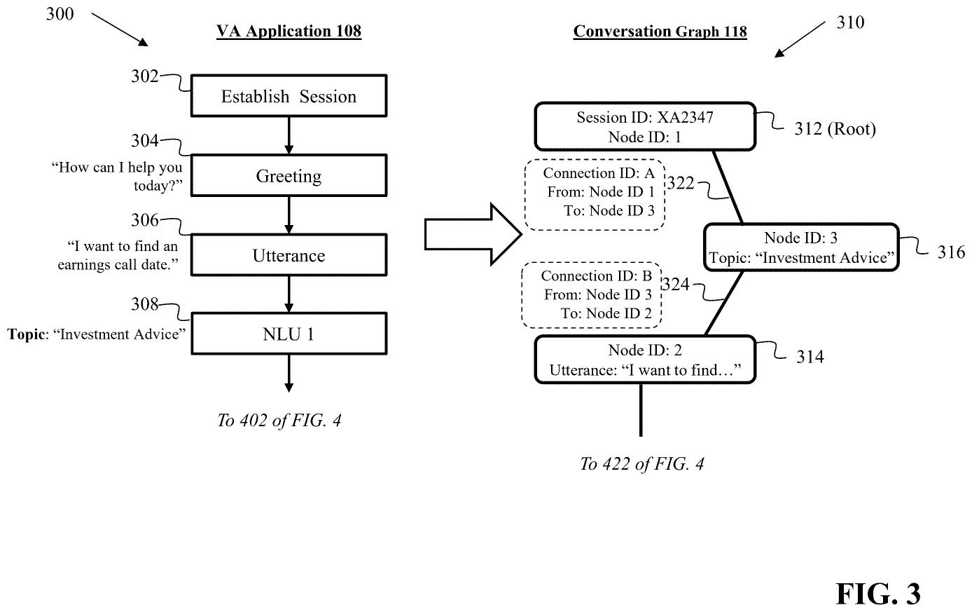

FIG. 3 is a diagram of a first exemplary portion 300 of a conversation session workflow executed by VA application 108 and corresponding portion 310 of the conversation graph 118 generated by graph construction and traversal module 114, relating to receipt and processing of an initial user utterance from client computing device 102. As shown in FIG. 3, VA application 108 establishes (302) a conversation session with client computing device 102 as described previously. UI module 110 of VA application 108 transmits (304) a greeting message to client computing device 102 for display to the end user as part of the conversation session. Concurrently, graph construction and traversal module 114 of VA application 108 provides instructions to dialogue memory 116 to instantiate a new conversation graph 118 data structure for the conversation—in some embodiments, VA application 108 includes a unique identifier (e.g., Session ID) for the conversation session. Dialogue memory 116 creates conversation graph 118 and generates root node 312 in the graph 118. As described above, each conversation graph 118 includes a root node to indicate to VA application 108 a starting point of the conversation session and the root node can indicate where application 108 should begin traversal of the conversation graph 118. As shown in FIG. 3, the root node 312 includes the Session ID as an attribute, along with a unique node identifier (e.g., Node ID: 1). UI module 110 of VA application 108 then listens for an utterance to be submitted from client computing device 102.

The user at client computing device 102 enters an utterance in the conversation session to, e.g., request information about an earnings call date, and client computing device 102 transmits the utterance to VA application 108. Utterance processing module 112 receives (306) the utterance for analysis. Concurrently, graph construction and traversal module 114 provides instructions to dialogue memory 116 to generate a new utterance node 314 in the conversation graph 118. As shown in FIG. 3, the new utterance node 314 includes a unique identifier (e.g., Node ID: 2) as an attribute and the captured utterance (i.e., “I want to find an earnings call date”) as another attribute. In some embodiments, the root node 312 and the utterance node 314 are not yet connected to any nodes.

Utterance processing module 112 processes (308) the utterance to determine, e.g., a topic associated with the utterance. In some embodiments, module 112 invokes an NLP/NLU service to interpret the utterance text string and generate a predicted intent/topic for the utterance. For example, the NLP/NLU service can interpret the utterance string “I want to find an earnings call date” as comprising the topic “Investment Advice” and return the topic value to utterance processing module 112. Concurrently, graph construction and traversal module 114 provides instructions to dialogue memory 116 to generate a new topic node 316 in the conversation graph 118. As shown in FIG. 3, the new topic node 316 includes a unique identifier (e.g., Node ID: 3) as an attribute and the identified topic (i.e., “Investment Advice”) as another attribute. In some embodiments, dialogue memory 118 can be configured to store a plurality of default or existing topic nodes that can be retrieved for insertion into a conversation graph—instead of creating a new topic node.

In some embodiments, once the nodes 312, 314, 316 are created in the conversation graph 118, graph construction and traversal module 114 connects the nodes to other nodes using connections (e.g., 322, 324). Generally, the connections denote a relationship between the connected nodes, and in some embodiments each connection can comprise one or more relationship attributes. Dialogue memory 116 can store the connections as, e.g., a data structure that comprises attributes include (i) a unique identifier for the connection, (ii) an identifier for the first node, and (iii) an identifier for the second node. In some embodiments, a connection data structure can include one or more attributes that define the relationship between the two connected nodes. For example, an utterance node containing a question submitted by the end user at client computing device 102 can be connected to an answer node containing the response to the user's question as generated by VA application 108. The connection between the two nodes can include an attribute defining the relationship of the answer node to the utterance node (e.g., “RESPONSE_OF”). The connection attributes are useful to enable VA application 108 to traverse the conversation graph 118 and understand the flow and context of the conversation, including how certain data elements and workflow processes are related to each other.

As described above, each node in the graph 118 is generated by graph construction and traversal module 114 in correspondence with each workflow event executed by VA application 108 during the conversation session. In some embodiments, module 114 can be configured to capture the workflow events from VA application 108 and process them in a batch for generation of the graph 118.

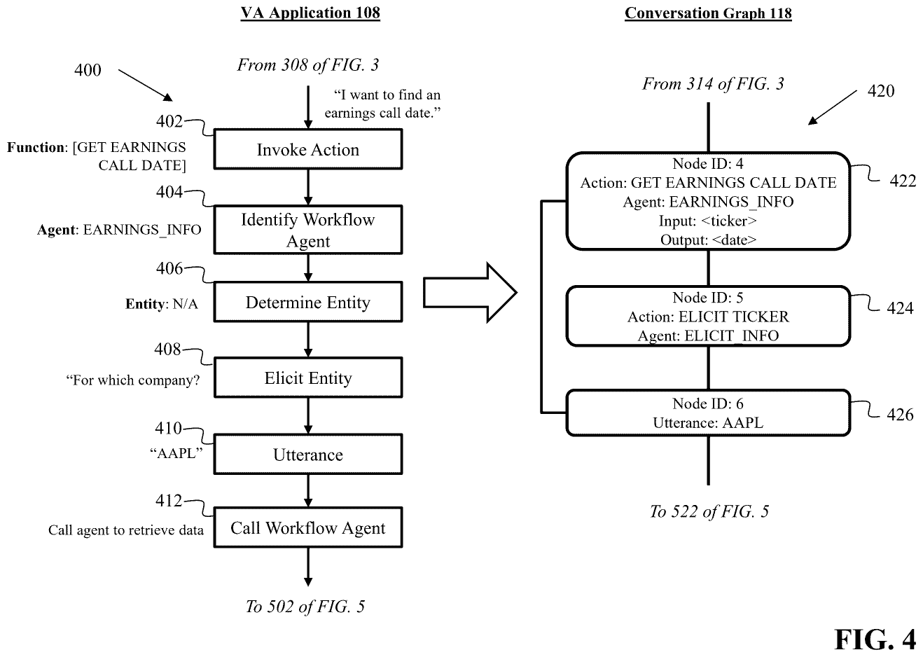

Turning back to FIG. 2, VA application 108 determines (step 210) a responsive action based upon the utterance and connects the utterance node (e.g., node 314) to an action node. FIG. 4 is a diagram of a second exemplary portion 400 of a conversation session workflow executed by VA application 108 and corresponding portion 420 of the conversation graph 118 generated by graph construction and traversal module 114, relating to determining a responsive action to an utterance. As shown in FIG. 4, VA application 108 analyzes the utterance submitted by the end user (“I want to find an earnings call date”) and determines (402) a responsive action to the utterance. In some embodiments, utterance processing module 112 can extract one or more keywords from the utterance and identify (404) a workflow agent that provides functionality associated with the keywords. For example, module 112 can use the keywords to perform a search of database 120 to identify one or more workflow agents that are linked to the keywords. A table in database 120 can map one or more keywords to a function call, API, or other indicia that references an executable workflow agent. Utterance processing module 112 can retrieve the indicia from database 120 for use in calling the workflow agent. In some embodiments, utterance processing module 112 can provide the utterance to another NLP/NLU service that parses the utterance (e.g., using a large language model) and returns a suggested workflow agent that can be invoked in response to the utterance. Upon determining the workflow agent that is suitable for execution to respond to the utterance, graph construction and traversal module 114 generates an action node (e.g., node 422) in the conversation graph 118 and connects the action node 422 to the utterance node (node 314 of FIG. 3) that comprises the utterance.

In some instances, VA application 108 may require additional input before application 108 can execute a workflow agent in response to the utterance. Using the above example utterance, VA application 108 may not have knowledge of the specific entity that the end user wants to find the earnings call date. When VA application 108 identifies the workflow agent that can be executed to retrieve earnings call information, VA application 108 can detect that the workflow agent requires an input parameter corresponding to a ticker symbol or name of a company. In some embodiments, VA application 108 can traverse the conversation graph 118 for the session to determine (406) whether one or more nodes (e.g., context nodes) in the graph contain relevant information to execute the workflow agent. For example, the end user may have previously entered a company name or ticker symbol (relating to an earlier utterance) and the information can be stored in conversation graph 118. VA application 108 can identify the context node(s) and retrieve the information for use as input to the workflow agent. In cases where conversation graph 118 does not contain relevant context information, VA application 108 can determine a further responsive action which (408) elicits the required information from the end user. Concurrently, graph construction and traversal module 114 generates another action node 424 in the conversation graph 118 relating to the elicitation of the ticker symbol and/or company name. VA application 108 can call another workflow agent (e.g., ELICIT_INFO) which generates a message that requests, e.g., a ticker symbol or name for the entity that the user is interested in. VA application 108 can capture the output of this workflow agent as the elicitation message and transmit the message to client computing device 102. For example, VA application 108 can transmit a message to client computing device 102, i.e., “For which company would you like the earnings call date?” In response, the end user can submit (410) another utterance—i.e., “AAPL” or “Apple, Inc.” Concurrently, graph construction and traversal module 114 generates a new utterance node 426 in the conversation graph 118 for the information utterance provided by the end user. Upon receiving the utterance, VA application 108 can execute (412) the identified workflow agent using the input parameter provided by the user to retrieve the relevant earnings call data.

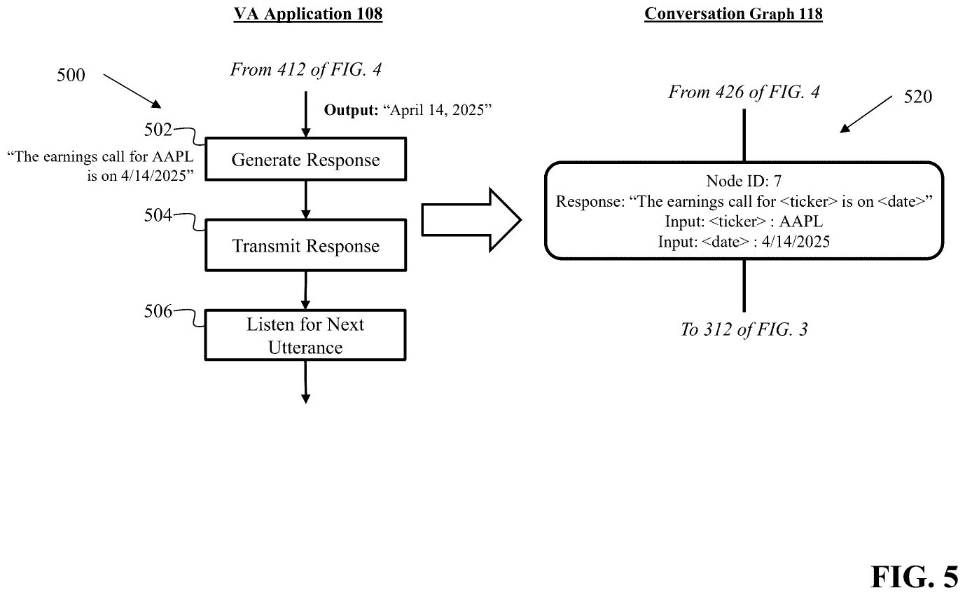

Turning back to FIG. 2, VA application 108 executes (step 210) the responsive action to generate an answer to the utterance and connects the action node to an answer node for the answer in the conversation graph 118. FIG. 5 is a diagram of a third exemplary portion 500 of a conversation session workflow executed by VA application 108 and corresponding portion 520 of the conversation graph 118 generated by graph construction and traversal module 114, relating to executing the responsive action and generating a response. VA application 108 receives output data from execution of the workflow agent as described above (e.g., the date “Apr. 14, 2025”) and generates (502) a response message that includes the output. Concurrently, graph construction and traversal module 114 generates an answer node 522 in the conversation graph 118 and connects the previous utterance node 426 to the answer node 522. As shown in FIG. 5, the answer node 522 includes the response text string template attribute and two input value attributes: <ticker> and <date>. Module 114 can populate the input value attributes with the corresponding values as stored in, e.g., utterance node 426 and/or action node 422.

UI module 110 of VA application 108 generates a new response message in the conversation session that comprises a customized version of the response template to include the specific values for the ticker symbol and date—namely, “The earnings call for AAPL is on Apr. 14, 2025.” UI module 110 transmits (504) the response message to client computing device 102 for display to the end user during the conversation session. Then, VA application 108 listens for the next utterance to be submitted by the user at client computing device 102 and can repeat the above processing steps for each subsequent utterance.

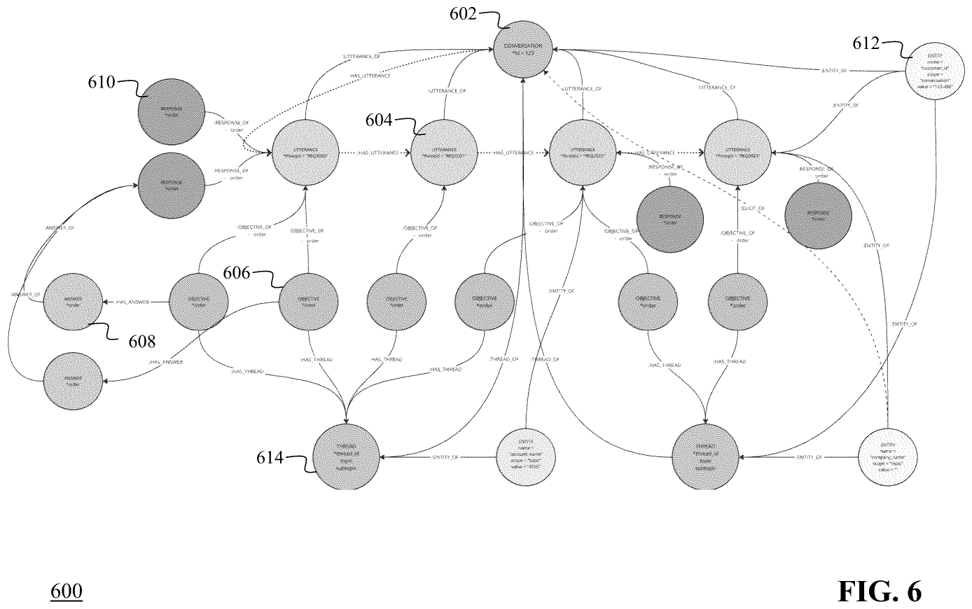

FIG. 6 is a diagram of an exemplary conversation graph 600 generated from a complete conversation session between client computing device 102 and VA application 108. As shown in FIG. 6, the graph comprises root node 602, a plurality of utterance nodes (e.g., 604), a plurality of objective nodes (e.g., 606), a plurality of answer nodes (e.g., 608) and response nodes (e.g., 610). In this example, conversation graph 118 includes separate nodes for answers (which represent the output from workflow agents executing to determine answers to user utterances) and for responses (which represent the response message generated by VA application 108 that contains the answer). It should be appreciated that the examples of FIG. 5 above consolidates these two node types into a single answer node type, although either structure can be used. The conversation graph 600 in FIG. 6 also includes entity nodes (e.g., 612) that comprise context information generated during the conversation session.

In some embodiments, the conversation graph can also include thread nodes (e.g., 614). As can be appreciated, user utterances may include multiple topics or intents. As such, these utterances may need to be broken down into a plurality of sub-utterances and chained together in different ways for VA application 108 to provide a response. For example, a user utterance could be: “What is the yield of my cash positions and are there better yielding money markets?” or “Are there better yielding money market funds than the yields of my current cash positions?” While syntactically dissimilar, these utterances have similar meanings.

In this example, VA application 108 can be configured to break the utterance into two sub-utterances, i.e., 1) “What is the yield of my cash position” and 2) “Are there better yielding money markets?” Based upon the intents or topics involved, VA application 108 can prioritize processing of the sub-utterances so that a complete response to the initial utterance can be provided. As an example, VA application 108 can process sub-utterance #1 first to get a corresponding output, namely, the percentage yield of the user's cash position. Then, the output of sub-utterance #1 is used by VA application 108 as an input for processing sub-utterance #2—to determine other money markets that have a better yield than the user's cash position. As can be appreciated, if these sub-utterances were processed in the reverse order, VA application 108 would be unable to generate an output for sub-utterance #2 because application 108 would be missing necessary information that is provided from sub-utterance #1. In view of the above prioritization requirement, conversation graph 118 can be configured with thread nodes that track and manage the flow of execution of sub-utterances by VA application 108 to provide an overall response to a user utterance.

Another important feature of the methods and systems described herein is the ability for VA application 108 to use conversation graph 118 in tracking the conversation state across multiple utterances/sub-utterances/topics. In some instances, VA application 108 may request additional information from the user at client computing device 102 in order to respond to an question utterance, and the next utterance from the user may not provide that information but instead pose a further question. Using the above example, a user may submit the utterance: “When is the next earnings call date?” VA application 108 can be configured to generate the following message in response: “For which company do you need the earnings call date?” In the above example, the user responds with the utterance “AAPL” and VA application 108 can execute functionality to retrieve the corresponding information in response to the user request.

In some circumstances, instead of submitting a ticker symbol, the user may respond with a further inquiry to VA application 108, i.e., “What earnings call dates can you provide?” Under the conversation graph framework described herein, this new utterance generates a corresponding utterance node in the graph and VA application 108 can generate a corresponding answer node containing the response “Any publicly traded stocks.” However, the earlier message to the user is still in a state of eliciting because the user did not provide a specific response that fulfills the request. Advantageously, VA application 108 can leverage the conversation graph 118 to track state across multiple topics, utterances, and sub-utterances without requiring VA application 108 to revert to earlier contexts or ‘forget’ information that the application 108 has previously requested.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

The computer program can be deployed in a cloud computing environment (e.g., Amazon® AWS, Microsoft® Azure, IBM® Cloud™). A cloud computing environment includes a collection of computing resources provided as a service to one or more remote computing devices that connect to the cloud computing environment via a service account—which allows access to the aforementioned computing resources. Cloud applications use various resources that are distributed within the cloud computing environment, across availability zones, and/or across multiple computing environments or data centers. Cloud applications are hosted as a service and use transitory, temporary, and/or persistent storage to store their data. These applications leverage cloud infrastructure that eliminates the need for continuous monitoring of computing infrastructure by the application developers, such as provisioning servers, clusters, virtual machines, storage devices, and/or network resources. Instead, developers use resources in the cloud computing environment to build and run the application and store relevant data.

Method steps can be performed by one or more processors executing a computer program to perform functions of the invention by operating on input data and/or generating output data. Subroutines can refer to portions of the stored computer program and/or the processor, and/or the special circuitry that implement one or more functions. Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random-access memory or both. The essential elements of a computer are a processor for executing instructions and one or more memory devices for storing instructions and/or data. Exemplary processors can include, but are not limited to, integrated circuit (IC) microprocessors (including single-core and multi-core processors). Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), an ASIC (application-specific integrated circuit), Graphics Processing Unit (GPU) hardware (integrated and/or discrete), another type of specialized processor or processors configured to carry out the method steps, or the like.

Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices (e.g., NAND flash memory, solid state drives (SSD)); magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above-described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). The systems and methods described herein can be configured to interact with a user via wearable computing devices, such as an augmented reality (AR) appliance, a virtual reality (VR) appliance, a mixed reality (MR) appliance, or another type of device. Exemplary wearable computing devices can include, but are not limited to, headsets such as Meta™ Quest 3™ and Apple® Vision Pro™. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above-described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above-described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN),), a private IP network, an IP private branch exchange (IPBX), a wireless network (e.g., radio access network (RAN), Bluetooth™, near field communications (NFC) network, Wi-Fi™, WiMAX™, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), cellular networks, and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE), cellular (e.g., 4G, 5G), and/or other communication protocols.

Devices of the computing system can include, for example, a computer, a computer with a browser device, a telephone, an IP phone, a mobile device (e.g., cellular phone, personal digital assistant (PDA) device, smartphone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Safari™ from Apple, Inc., Microsoft® Edge® from Microsoft Corporation, and/or Mozilla® Firefox from Mozilla Corporation). Mobile computing devices include, for example, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

The methods and systems described herein can utilize artificial intelligence (AI) and/or machine learning (ML) algorithms to process data and/or control computing devices. In one example, a classification model, is a trained ML algorithm that receives and analyzes input to generate corresponding output, most often a classification and/or label of the input according to a particular framework.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A computer system for graph-based conversation state tracking in virtual assistant communication sessions, the system comprising a server computing device having a memory that stores computer-executable instructions and a processor that executes the computer-executable instructions to:
generate a conversation graph associated with a chat-based communication session between a virtual assistant application of the server computing device and a client computing device;
capture a plurality of utterances generated by a user of the client computing device during the chat-based communication session;
for each of the plurality of utterances:
generate an utterance node in the conversation graph based upon the utterance;
identify a topic associated with the utterance and connect the utterance node to a topic node for the topic in the conversation graph;
determine a responsive action based upon the utterance and connect the utterance node to an action node for the responsive action in the conversation graph;
execute the responsive action to generate an answer to the utterance and connect the action node to an answer node for the answer in the conversation graph; and
transmit a message to the client computing device comprising the generated answer for display to the user during the chat-based communication session.

2. The system of claim 1, wherein generating a conversation graph comprises creating a root node in the conversation graph upon establishing the chat-based communication session between the virtual assistant application of the server computing device and the client computing device, the root node including a conversation identifier attribute.

3. The system of claim 2, wherein generating an utterance node in the conversation graph comprises connecting the utterance node to the root node.

4. The system of claim 2, wherein establishing the chat-based communication session between the virtual assistant application of the server computing device and the client computing device comprises:
determining an identity of the user based upon indicia received from the client computing device;
retrieving one or more user profile attributes based upon the identity of the user;
generating one or more identity nodes in the conversation graph based upon the user profile attributes; and
connecting the one or more identity nodes to the root node.

5. The system of claim 1, wherein connecting the utterance node to a topic node for the topic in the conversation graph comprises:
determining whether a topic node for the topic exists in the conversation graph;
when the topic node for the topic exists in the conversation graph, connecting the utterance node to the existing topic node; and
when the topic node for the topic does not exist in the conversation graph, generating a new topic node for the topic and connecting the utterance node to the new topic node.

6. The system of claim 1, wherein the action node for the responsive action in the conversation graph comprises a function call that, when executed, connects the server computing device to a data source for retrieval of data used to generate the answer to the utterance.

7. The system of claim 1, wherein the action node for the responsive action in the conversation graph comprises a function call that, when executed, retrieves data used to generate the answer to the utterance from another node in the conversation graph.

8. The system of claim 1, wherein for each of the plurality of utterances, the server computing device determines whether the utterance comprises a plurality of sub-utterances.

9. The system of claim 8, wherein for each utterance that comprises a plurality of sub-utterances, the server computing device:
generates an utterance node in the conversation graph based upon the sub-utterance;
identifies a topic associated with the sub-utterance and connects the utterance node to a topic node for the topic in the conversation graph;
determines a responsive action based upon the sub-utterance and connects the utterance node to an action node for the responsive action in the conversation graph;
executes the responsive action to generate an answer to the sub-utterance and connects the action node to an answer node for the answer in the conversation graph; and
transmits a message to the client computing device comprising the generated answer for display to the user during the chat-based communication session.

10. The system of claim 8, wherein for the plurality of sub-utterances, the server computing device:
generates a first utterance node in the conversation graph based upon a first sub-utterance of the plurality of sub-utterances;
identifies a topic associated with the first sub-utterance and connects the first utterance node to a topic node for the topic in the conversation graph;
determines a need for further sub-utterance processing based upon the first sub-utterance;
generates a second utterance node in the conversation graph based upon a second sub-utterance of the plurality of sub-utterances and connects the second utterance node to the first utterance node;
determines a responsive action based upon the second sub-utterance and connects the second utterance node to an action node for the responsive action in the conversation graph;
executes the responsive action to generate an answer to the second sub-utterance and connects the action node to an answer node for the answer in the conversation graph; and
transmits a message to the client computing device comprising the generated answer for display to the user during the chat-based communication session.

11. The system of claim 1, wherein when the chat-based communication session has ended, the server computing device analyzes the conversation graph to: identify conversation anomalies;
determine common topics between the conversation graph and conversation graphs for other users; extract key nodes from the conversation graph; predict relationships between nodes for subsequent communication sessions; and determine conversation dependencies.

12. The system of claim 1, wherein the conversation graph comprises a short-term memory graph data structure.

13. A computerized method of graph-based conversation state tracking in virtual assistant communication sessions, the method comprising:
generating, by a server computing device, a conversation graph associated with a chat-based communication session between a virtual assistant application of the server computing device and a client computing device;
capturing, by the server computing device, a plurality of utterances generated by a user of the client computing device during the chat-based communication session;
for each of the plurality of utterances:
generating, by the server computing device, an utterance node in the conversation graph based upon the utterance;
identifying, by the server computing device, a topic associated with the utterance and connect the utterance node to a topic node for the topic in the conversation graph;
determining, by the server computing device, a responsive action based upon the utterance and connect the utterance node to an action node for the responsive action in the conversation graph;
executing, by the server computing device, the responsive action to generate an answer to the utterance and connect the action node to an answer node for the answer in the conversation graph; and
transmitting, by the server computing device, a message to the client computing device comprising the generated answer for display to the user during the chat-based communication session.

14. The method of claim 13, wherein generating a conversation graph comprises creating a root node in the conversation graph upon establishing the chat-based communication session between the virtual assistant application of the server computing device and the client computing device, the root node including a conversation identifier attribute.

15. The method of claim 14, wherein generating an utterance node in the conversation graph comprises connecting the utterance node to the root node.

16. The method of claim 14, wherein establishing the chat-based communication session between the virtual assistant application of the server computing device and the client computing device comprises:
determining an identity of the user based upon indicia received from the client computing device;
retrieving one or more user profile attributes based upon the identity of the user;
generating one or more identity nodes in the conversation graph based upon the user profile attributes; and
connecting the one or more identity nodes to the root node.

17. The method of claim 13, wherein connecting the utterance node to a topic node for the topic in the conversation graph comprises:
determining whether a topic node for the topic exists in the conversation graph;
when the topic node for the topic exists in the conversation graph, connecting the utterance node to the existing topic node; and
when the topic node for the topic does not exist in the conversation graph, generating a new topic node for the topic and connecting the utterance node to the new topic node.

18. The method of claim 13, wherein the action node for the responsive action in the conversation graph comprises a function call that, when executed, connects the server computing device to a data source for retrieval of data used to generate the answer to the utterance.

19. The method of claim 13, wherein the action node for the responsive action in the conversation graph comprises a function call that, when executed, retrieves data used to generate the answer to the utterance from another node in the conversation graph.

20. The method of claim 13, further comprising determining, for each of the plurality of utterances, whether the utterance comprises a plurality of sub-utterances.

21. The method of claim 20, further comprising for each utterance that comprises a plurality of sub-utterances:
generating, by the server computing device, an utterance node in the conversation graph based upon the sub-utterance;
identifying, by the server computing device, a topic associated with the sub-utterance and connects the utterance node to a topic node for the topic in the conversation graph;
determining, by the server computing device, a responsive action based upon the sub-utterance and connects the utterance node to an action node for the responsive action in the conversation graph;
executing, by the server computing device, the responsive action to generate an answer to the sub-utterance and connects the action node to an answer node for the answer in the conversation graph; and
transmitting, by the server computing device, a message to the client computing device comprising the generated answer for display to the user during the chat-based communication session.

22. The method of claim 20, further comprising for the plurality of sub-utterances:
generating a first utterance node in the conversation graph based upon a first sub-utterance of the plurality of sub-utterances;
identifying a topic associated with the first sub-utterance and connects the first utterance node to a topic node for the topic in the conversation graph;
determining a need for further sub-utterance processing based upon the first sub-utterance;
generating a second utterance node in the conversation graph based upon a second sub-utterance of the plurality of sub-utterances and connects the second utterance node to the first utterance node;
determining a responsive action based upon the second sub-utterance and connects the second utterance node to an action node for the responsive action in the conversation graph;
executing the responsive action to generate an answer to the second sub-utterance and connects the action node to an answer node for the answer in the conversation graph; and
transmitting a message to the client computing device comprising the generated answer for display to the user during the chat-based communication session.

23. The method of claim 13, further comprising analyzing, by the server computing device, the conversation graph when the chat-based communication session has ended to: identify conversation anomalies; determine common topics between the conversation graph and conversation graphs for other users; extract key nodes from the conversation graph; predict relationships between nodes for subsequent communication sessions; and determine conversation dependencies.

24. The method of claim 13, further comprising storing, by the server computing device, the conversation graph as a short-term memory graph data structure.
